(19) United States
(12) Patent Application Publication
(10) Pub. No.: US 2007/0203289 A1
(43) Pub. Date: Aug. 30, 2007

(54) Aqueous polyurethane dispersions obtained by the use of caesium salts

(75) Inventors: Bernd Bruchmann, Freinsheim (DE); Karl Haberle, Speyer (DE); Klaus Dieter Horner, Mannheim (DE); Reinhard Treiber, Leimen (DE); Thomas Renz, Ludwigshafen (DE); Hermann Seyffer, Heidelberg (DE); Barbel Meyer, Lauta (DE); Lothar Wolf, Torno (DE); Paul Knochel, Muenchen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/797,004

(22) Filed: Apr. 30, 2007

Related U.S. Application Data
(63) Continuation of application No. 10/497,850, filed on Jun. 7, 2004.

(30) Foreign Application Priority Data
Dec. 12, 2001 (DE) 101 61 156.0

(51) Int. Cl. C08K 3/00; C08G 18/08

(52) U.S. Cl. 524/589; 524/401

(57) ABSTRACT

Aqueous dispersions comprising a polyurethane composed of a) diisocyanates, b) diols of which
b₁) from 10 to 100 mol %, based on the total amount of diols (b), have a molecular weight of from 500 to 5000, and
b₂) from 0 to 90 mol %, based on the total amount of diols (b), have a molecular weight of from 60 to 500 g/mol, c) monomers other than the monomers (a) and (b), containing at least one isocyanate group or at least one isocyanate-reactive group and further carrying at least one hydrophilic group or potentially hydrophilic group by means of which the polyurethane is made dispersible in water, d) if desired, further, polyfunctional compounds other than the monomers (a) to (c), containing reactive groups which are alcoholic hydroxyl groups, primary or secondary amino groups or isocyanate groups, and e) if desired, monofunctional compounds which are other than the monomers (a) to (d) and contain a reactive group which is an alcoholic hydroxyl group, a primary or secondary amino group or an isocyanate group, obtainable by reacting the monomers a), b), c), and, where used, d) and e) in the presence of a cesium salt.

The present invention relates to aqueous dispersions comprising a polyurethane composed of
a) diisocyanates,
b) diols of which
b₁) from 10 to 100 mol %, based on the total amount of diols (b), have a molecular weight of from 500 to 5000, and
b₂) from 0 to 90 mol %, based on the total amount of diols (b), have a molecular weight of from 60 to 500 g/mol,
c) monomers other than the monomers (a) and (b), containing at least one isocyanate group or at least one isocyanate-reactive group and further carrying at least one hydrophilic group or potentially hydrophilic group by means of which the polyurethane is made dispersible in water,
d) if desired, further, polyfunctional compounds other than the monomers (a) to (c), containing reactive groups which are alcoholic hydroxyl groups, primary or secondary amino groups or isocyanate groups, and
e) if desired, monofunctional compounds which are other than the monomers (a) to (d) and contain a reactive-group which is an alcoholic hydroxyl group, a primary or secondary amino group or an isocyanate group,
   obtainable by reacting the monomers a), b), c), and, where used, d) and e) in the presence of a cesium salt.

The invention further relates to methods of coating, adhesively bonding, and impregnating articles made of different materials using these dispersions, to articles coated, adhesively bonded, and impregnated using these dispersions, and to the use of the dispersions of the invention as hydrolysis-resistant coating materials.

The use of aqueous dispersions comprising polyurethane (PU dispersions for short) to coat substrates such as textile or leather has been known for a long time (EP-A 595149).

In the preparation of aqueous polyurethane dispersions (also called PU dispersions below), the addition reaction, i.e., the reaction of the individual monomers with one another, is frequently conducted using catalysts. Well established for this purpose in particular are organotin compounds such as dibutyltin dilaurate (DEA 19959653). However, it is known that organotin compounds of this kind have a high toxicity, among other features, and accumulate undesirably in the environment owing to their poor degradability. The tin diorganyl compounds normally used are less hazardous than the tin triorganyl compounds, but commercial preparations of tin diorganyl compounds always contain certain fractions of tin triorganyl compounds, owing to the special preparation process.

DE-A 19917897 describes a process for preparing polyurethane foams from specific polyetherols using metal salt catalysts. It specifies salts composed of metals from main groups one and two, and a large number of anions. Particular preference is given to using potassium salts. That specification does not, however, disclose using such catalysts for preparing polyurethane dispersions.

Moreover, the earlier application DE-A 10133789 also discloses preparing polyurethane dispersions by conducting the addition reaction without the use of a catalyst. In this case, however, it is necessary to accept longer reaction times and possibly higher temperatures as well, among other factors.

It is an object of the present invention to remedy the disadvantages depicted above and to develop improved PU dispersions which are obtained using nontoxic catalysts, the catalysts used catalyzing substantially only the formation of the urethane. In the preparation of the polyurethane dispersions, moreover, the catalysts used should not catalyze any of the numerous other reactions of which isocyanate groups are capable, such as the formation of allophanates, isocyanurates or carbodiimides, for example, since this would lead only to unwanted branching of the polyurethane chain.

We have found that this object is achieved by the aqueous dispersions defined at the outset and by a process for preparing them. Moreover, a process for producing coatings, adhesive bonds, and impregnated systems has been developed. The present invention further extends to the articles thus coated, bonded and impregnated and to their use as hydrolysis-resistant coatings.

The aqueous dispersions of the invention comprise polyurethanes which in addition to other monomers are derived from diisocyanates a), with the diisocyanates a) used being preferably those which are commonly employed in polyurethane chemistry.

Monomers (a) are, in particular, diisocyanates X(NCO)₂, where X is an aliphatic hydrocarbon radical of 4 to 12 carbons, a cycloaliphatic or aromatic hydrocarbon radical of 6 to 15 carbons or an araliphatic hydrocarbon radical of 7 to 15 carbons. Examples of such diisocyanates are tetramethylene diisocyanate, hexamethylene diisocyanate (HDI), dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene, 4,4′-diisocyanatodiphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI), such as the trans/trans, the cis/cis and the cis/trans isomer, and mixtures of these compounds.

Such diisocyanates are available commercially.

Particularly important mixtures of these isocyanates are the mixtures of the respective structural isomers of diisocyanatotoluene and diisocyanatodiphenylmethane, especially the mixture comprising 80 mol % 2,4-diisocyanatotoluene and 20 mol % 2,6-diisocyanatotoluene. In addition, the mixtures of aromatic isocyanates, such as 2,4-diisocyanatotoluene and/or 2,6-diisocyanatotoluene, with aliphatic or cycloaliphatic isocyanates, such as hexamethylene diisocyanate or IPDI, are particularly advantageous, the preferred proportion of aliphatic to aromatic isocyanates being from 4:1 to 1:4.

In addition to the abovementioned isocyanates, other isocyanates which can be employed as compounds to synthesize the polyurethanes are those which carry not only the free isocyanate groups but also further, blocked isocyanate groups, examples being uretdione groups.

With a view to good film formation and elasticity, diols (b) which are ideally suitable are those diols (b1) which have a relatively high molecular weight of from 500 to 5000, preferably from about 1000 to 3000 g/mol.

The diols (b1) are, in particular, polyesterpolyols which are known, for example, from Ullmanns Encyklopädie der technischen Chemie, 4th Edition, Vol. 19,pp. 62 to 65. It is preferred to employ polyesterpolyols that are obtained by reacting dihydric alcohols with dibasic carboxylic acids. Instead of the free polycarboxylic acids it is also possible to use the corresponding polycarboxylic anhydrides or corresponding polycarboxylic esters of lower alcohols, or mixtures thereof, to prepare the polyesterpolyols. The polycarboxylic acids can be aliphatic, cycloaliphatic, araliphatic, aromatic or heterocyclic and can be unsubstituted or substituted, by halogen atoms, for example, and/or saturated or unsaturated. Examples are suberic, azelaic, phthalic and isophthalic acid, phthalic, tetrahydrophthalic, hexahydrophthalic, tetrachlorophthalic, endomethylenetetrahydrophthalic, glutaric and maleic anhydride, maleic acid, fumaric acid and dimeric fatty acids. Preference is given to dicarboxylic acids of the formula HOOC—(CH₂)_{y}—COOH, where y is a number from 1 to 20, preferably an even number from 2 to 20, examples being succinic, adipic, sebacic and dodecanedicarboxylic acids.

Examples of suitable polyhydric alcohols are ethylene glycol, 1,2-propanediol, 1,3-propanediol, 1,3-butanediol, 1,4-butenediol, 1,4-butynediol, 1,5-pentanediol, neopentyl glycol, bis(hydroxymethyl)cyclohexanes such as 1,4-bis(hydroxymethyl)cyclohexane, 2-methyl-1,3-propanediol, methylpentanediols, and also diethylene glycol, triethylene glycol, tetraethylene glycol, polyethylene glycol, dipropylene glycol, polypropylene glycol, dibutylene glycol and polybutylene glycols. Preference is given to alcohols of the formula HO—(CH₂)ₓ—OH, where x is a number from 1 to 20, preferably an even number from 2 to 20. Examples of such alcohols are ethylene glycol, 1,4-butanediol, 1,6-hexanediol, 1,8-octanediol and 1,12-dodecanediol. Preference extends to neopentyl glycol.

Also suitable are polycarbonatediols, as can be obtained, for example, by reaction of phosgene with an excess of the low molecular mass alcohols cited as structural components for the polyesterpolyols.

Lactone-based polyesterdiols are also suitable, these being homopolymers or copolymers of lactones, preferably hydroxy-terminal adducts of lactones with suitable difunctional starter molecules. Suitable lactones are preferably those derived from compounds of the formula HO—(CH₂)_{z}—COOH, where z is from 1 to 20 and one hydrogen of a methylene unit can also be substituted by a C₁-C₄-alkyl. Examples are ε-caprolactone, β-propiolactone, γ-butyrolactone and/or methyl-ε-caprolactone, and mixtures thereof. Examples of suitable starter components are the low molecular mass dihydric alcohols cited above as structural components for the polyesterpolyols. The corresponding polymers of ε-caprolactone are particularly preferred. Lower polyesterdiols or polyetherdiols can also be employed as starters for preparing the lactone polymers. Instead of the polymers of lactones it is also possible to employ the corresponding, chemically equivalent polycondensates of the hydroxycarboxylic acids which correspond to the lactones.

Further suitable monomers (b1) are polyetherdiols. They are obtainable in particular by addition polymerization of ethylene. oxide, propylene oxide, butylene oxide, tetrahydrofuran, styrene oxide or epichlorohydrin with itself, in the presence, for example, of BF₃, or by addition reaction of these compounds, alone or in a mixture or in succession, onto starter components containing reactive hydrogens, such as alcohols or amines, examples being water, ethylene glycol, 1,2-propanediol, 1,3-propanediol, 1,2-bis(4-hydroxydiphenyl)propane or aniline. Particular preference is given to polytetrahydrofuran having a molecular weight of from 240 to 5000 and, in particular, from 500 to 4500. Mixtures of polyesterdiols and polyetherdiols may also be used as monomers (b1).

Likewise suitable are polyhydroxyolefins, preferably those having 2 terminal hydroxyls, examples being α,ω-dihydroxypolybutadiene, α,ω-dihydroxypolymethacrylates or α,ω-dihydroxypolyacrylates as monomers (b1). Such compounds are known, for example, from EP-A-0622378. Further suitable polyols are polyacetals, polysiloxanes and alkyd resins.

The polyols can also be employed as mixtures in proportions of from 0.1:1 to 1:9.

The hardness and the modulus of elasticity of the polyurethanes can be raised by employing as diols (b) not only the diols (b1) but also low molecular mass diols (b2) having a molecular weight of from about 60 to 500, preferably from 62 to 200 g/mol.

Compounds employed as monomers (b2) are in particular the structural components of the short-chain alkanediols cited for the preparation of polyesterpolyols, preference being given to the diols having 2 to 12 carbons, to the unbranched diols having 2 to 12 carbons and an even number of carbons, and to 1,5-pentanediol and neopentyl glycol.

The proportion of the diols (b1), based on the overall amount of diols (b), is preferably from 10 to 100 mol %, and the proportion of monomers (b2), based on the overall amount of diols (b), is from 0 to 90 mol %. With particular preference the ratio of the diols (b1) to the monomers (b2) is from 0.1:1 to 5:1, especially from 0.2:1 to 2:1.

In order to render the polyurethanes dispersible in water they are synthesized not only from components (a), (b) and possibly (d) but also from monomers (c) which are different from components (a), (b) and (d) and which carry at least one isocyanate group or at least one isocyanate-reactive group and, in addition, at least one hydrophilic group or a group which can be converted into a hydrophilic group. In the text below the term hydrophilic groups or potentially hydrophilic groups is shortened to (potentially) hydrophilic groups. The (potentially) hydrophilic groups react with isocyanates much more slowly than do the functional groups of the monomers used to build up the polymer main chain.

The proportion of components having (potentially) hydrophilic groups among the overall amount of components (a), (b), (c), (d) and (e) is generally such that the molar amount of the (potentially) hydrophilic groups, based on the amount by weight of all monomers (a) to (e), is from 30 to 1000 mmol, preferably from 50 to 500 and, with particular preference, from 80 to 300 mmol/kg.

The (potentially) hydrophilic groups can be nonionic or, preferably, (potentially) ionic hydrophilic groups.

Suitable nonionic hydrophilic groups are especially polyethylene glycol ethers made up of preferably from 5 to 100, more preferably from 10 to 80, repeating ethylene oxide units. The amount of polyethylene oxide units is generally from 0 to 10, preferably from 0 to 6, % by weight, based on the amount of weight of all monomers (a) to (e).

Preferred monomers having nonionic hydrophilic groups are polyethylene oxide diols, polyethylene oxide monools and the reaction products of a polyethylene glycol and a diisocyanate which carry a terminally etherified polyethylene glycol radical. Such diisocyanates and processes for their preparation are specified in the patents U.S. Pat. No. 3,905,929 and U.S. Pat. No. 3,920,598.

Ionic hydrophilic groups are, in particular, anionic groups, such as the sulfonate, carboxylate and phosphate groups in the form of their alkali metal salts or ammonium salts, and also cationic groups such as amonium groups, especially protonated tertiary amino groups or quaternary ammonium groups.

Potentially ionic hydrophilic groups are, in particular, those which can be converted by simple neutralization, hydrolysis or quaternization reactions into the abovementioned ionic hydrophilic groups, examples thus being carboxyl or tertiary amino groups.

(Potentially) ionic monomers (c) are described in detail in, for example, Ullmanns Encyklopädie der technischen Chemie, 4th edition, Vol. 19, pp. 311-313 and, for example, in DE-A 1 495 745.

Monomers having tertiary amino groups, in particular, are of especial practical importance as (potentially) cationic monomers (c), examples being: tris(hydroxyalkyl)amines, N,N′-bis(hydroxy-alkyl)alkylamines, N-hydroxyalkyl-dialkylamines, tris(aminoalkyl)amines, N,N′-bis(aminoalkyl)alkylamines, N-aminoalkyl-dialkylamines, the alkyls, and alkanediyl units of these tertiary amines consisting independently of one another of 1 to 6 carbons. Also suitable are polyethers containing tertiary nitrogens and preferably two terminal hydroxyls, as are obtainable in a conventional manner by, for example, alkoxylating amines having two hydrogens attached to the amine nitrogen, examples being methylamine, aniline and N,N′-dimethylhydrazine. Polyethers of this kind generally have a molar weight of from 500 to 6000 g/mol.

These tertiary amines are converted either with acids, preferably strong mineral acids such as phosphoric acid, sulfuric acid or hydrohalic acids, or strong organic acids, or by reaction with appropriate quaternizing agents such as C₁-C₆-alkyl halides or benzyl halides, for example bromides or chlorides, into the ammonium salts.

Suitable monomers having (potentially) anionic groups are, conventionally, aliphatic, cycloaliphatic, araliphatic or aromatic carboxylic and sulfonic acids which carry at least one alcoholic hydroxyl or at least one primary or secondary amino group. Preference is given to dihydroxyalkylcarboxylic acids, especially those having 3 to 10 carbons, as are also described in U.S. Pat. No. 3,412,054. Particular preference is given to compounds of the formula (c₁) 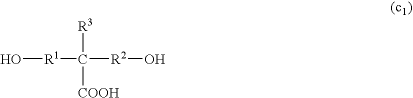
where R¹ and R² are C₁-C₄-alkanediyl and R³ is C₁-C₄-alkyl, and especially to dimethylolpropionic acid (DMPA).

Corresponding dihydroxysulfonic and dihydroxyphosphonic acids, such as 2,3-dihydroxypropanephosphonic acid, are also suitable.

Compounds otherwise suitable are dihydroxy compounds having a molecular weight of more than 500 up to 10,000 g/mol and at least 2 carboxylate groups, which are known from DE-A 39 11 827. They are obtainable by reacting dihydroxy compounds with tetra-carboxylic dianhydrides, such as pyromellitic dianhydride or cyclopentanetetracarboxylic dianhydride, in a molar ratio of from 2:1 to 1.05:1 in a polyaddition reaction. Particularly suitable dihydroxy compounds are the monomers (b2) listed as chain extenders, and the diols (b1).

Suitable monomers (c) having isocyanate-reactive amino groups are amino carboxylic acids such as lysine, β-alanine or the adducts specified in DE-A-20 34 479 of aliphatic diprimary diamines with α,β-unsaturated carboxylic or sulfonic acids.

Such compounds conform for example to the formula (c₂)
H₂N—R⁴—NH—R⁵—X (C₂)
where
R⁴ and R⁵ independently of one another are a C₁-C₆-alkanediyl, preferably ethylene,
and X is COOH or SO₃H.

Particularly preferred compounds of the formula (c₂) are N-(2-aminoethyl)-2-aminoethanecarboxylic acid and N-(2-aminoethyl)-2-aminoethanesulfonic acid and the corresponding alkali metal salts, Na being the particularly preferred counterion.

Also particularly preferred are the adducts of the abovementioned aliphatic diprimary diamines with 2-acrylamido-2-methyl-propanesulfonic acid, as are described, for example, in DE-C 1 954 090.

Insofar as monomers having potentially ionic groups are employed, their conversion into the ionic form can take place before or during, but preferably after, the isocyanate polyaddition reaction, since the solubility of the ionic monomers in the reaction mixture is in many cases poor. With particular preference, the sulfonate or carboxylate groups are in the form of their salts with an alkali metal ion or ammonium ion as counterion.

The monomers (d), which are different from the monomers (a) to (c) and may also be constituents of the polyurethane, serve generally for crosslinking or chain extension. They are generally nonphenolic alcohols with a functionality of more than two, amines having 2 or more primary and/or secondary amino groups, and compounds which in addition to one or more alcoholic hydroxyls carry one or more primary and/or secondary amino groups.

Examples of alcohols having a functionality of more than 2 which can be used to establish a certain degree of branching or crosslinking are trimethylolpropane, glycerol and sugars.

Also suitable are monoalcohols which in addition to the hydroxyl carry a further isocyanate-reactive group, such as monoalcohols having one or more primary and/or secondary amino groups; for example, monoethanolamine.

Polyamines having 2 or more primary and/or secondary amino groups are employed in particular when chain extension and/or crosslinking is to take place in the presence of water, since amines generally react more quickly with isocyanates than do alcohols or water. This is in many cases necessary when the desire is for aqueous dispersions of crosslinked polyurethanes, or polyurethanes of high molar weight. In such cases a procedure is followed in which prepolymers with isocyanate groups are prepared, are rapidly dispersed in water and then are subjected to chain extension or crosslinking by adding compounds having two or more isocyanate-reactive amino groups.

Amines suitable for this purpose are, in general, polyfunctional amines with a molar weight in the range from 32 to 500 g/mol, preferably from 60 to 300 g/mol, having at least two amino groups selected from the group consisting of primary and secondary amino groups. Examples are diamines such as diaminoethane, diaminopropanes, diaminobutanes, diaminohexanes, piperazine, 2,5-dimethylpiperazine, amino-3-aminomethyl-3,5,5-trimethyl-cyclohexane (isophoronediamine, IPDA), 4,4′-diaminodicyclo-hexylmethane, 1,4-diaminocyclohexane, aminoethylethanolamine, hydrazine, hydrazine hydrate or triamines such as diethylenetriamine or 1,8-diamino-4-aminomethyloctane.

The amines can also be employed in blocked form, for example in the form of the corresponding ketimines (see eg. CA-A-1 129 128), ketazines (cf. eg. U.S. Pat. No. 4,269,748) or amine salts (see U.S. Pat. No. 4,292,226). Oxazolidines too, as are used, for example, in U.S. Pat. No. 4,192,937, are capped polyamines which can be employed to chain extend the prepolymers in the preparation of the novel polyurethanes. When capped polyamines of this kind are used they are generally mixed with the prepolymers in the absence of water and this mixture is subsequently mixed with the dispersion water or with a portion thereof so that the corresponding polyamines are liberated by hydrolysis.

It is preferred to use mixtures of diamines and triamines, especially mixtures of isophoronediamine (IPDA) and diethylenetriamine (DETA).

The polyurethanes contain preferably from 1 to 30 mol %, especially from 4 to 25 mol %, based on the total amount of components (b) and (d), of a polyamine having at least 2 isocyanate-reactive amino groups, as monomers (d).

Examples of alcohols having a functionality of more than 2 which can be used to establish a certain degree of branching or crosslinking are trimethylolpropane, glycerol and sugars.

For the same purpose it is also possible, as monomers (d), to employ isocyanates with a functionality of more than two. Examples of commercial compounds are the isocyanurate or the biuret of hexamethylene diisocyanate.

Monomers (e), which can additionally be used if desired, are monoisocyanates, monoalcohols and monoprimary and monosecondary amines. In general their proportion is not more than 10 mol %, based on the overall molar amount of the monomers. These monofunctional compounds usually carry other functional groups, such as olefinic groups or carbonyl groups, and serve to introduce functional groups into the polyurethane which enable the polyurethane to be dispersed or crosslinked or to undergo further polymer-analogous reaction. Monomers suitable for this purpose are isopropenyl-α,α-dimethylbenzyl isocyanate (TMI) and esters of acrylic or methacrylic acid, such as hydroxyethyl acrylate or hydroxyethyl methacrylate.

Coatings having a particularly good profile of properties are obtained in particular when the monomers (a) employed comprise essentially only aliphatic diisocyanates, cycloaliphatic diisocyanates or TMXDI, and when the monomer (b1) employed essentially comprises only polyesterdiols synthesized from the abovementioned aliphatic diols and diacids.

An excellent supplement to this monomer combination, as component (c), comprises salts of diamino acids—very particularly N-(2-aminoethyl)-2-aminoethanesulfonic acid, N-(2-aminoethyl)-2-aminoethanecarboxylic acid and/or their corresponding alkali metal salts, the Na salts being the best suited—and, as component (d), a mixture of DETA/IPDA.

In the field of polyurethane chemistry it is generally known how the molecular weight of the polyurethanes can be adjusted by choosing the proportions of the co-reactive monomers and by the arithmetic mean of the number of reactive functional groups per molecule.

Components (a) to (e) and their respective molar amounts are normally chosen such that the ratio A:B, where
A) is the molar amount of isocyanate groups and
B) is the sum of the molar amount of the hydroxyls and the molar amount of the functional groups which are able to react with isocyanates in an addition reaction,
   is from 0.5:1 to 2:1, preferably from 0.8:1 to 1.5 and, with particular preference, from 0.9:1 to 1.2:1. With very particular preference the ratio A:B is as close as possible to 1:1.

The monomers (a) to (e) employed carry on average usually from 1.5 to 2.5, preferably from 1.9 to 2.1 and, with particular preference, 2.0 isocyanate groups and/or functional groups which are able to react with isocyanates in an addition reaction.

The polyaddition of components (a) to (e) for preparing the polyurethane present in the aqueous dispersions of the invention can take place at from 20 to 180° C., preferably from 70 to 150° C., under atmospheric pressure or under autogenous pressure.

The reaction times required are normally from 1 to 20 hours, especially from 1.5 to 10 hours. It is known in the field of polyurethane chemistry how the reaction time is influenced by a host of parameters such as temperature, monomer concentration and monomer reactivity.

The polyaddition of the monomers a), b), c), and, where appropriate, d) and e) for preparing the PU dispersion of the invention takes place in the presence of a cesium salt. Preferred cesium salts are compounds in which the following anions are used: F³¹ , Cl³¹ , ClO³¹ , ClO₃⁻, ClO₄⁻, Br³¹ , I³¹ , IO₃⁻, CN³¹ , OCN⁻, NO₂⁻, NO₃⁻, HCO₃⁻, CO₃²⁻, S²⁻, SH⁻, HSO₃⁻, SO₃²⁻, HSO₄²⁻, SO₄²⁻, S₂O₂²⁻, S₂ O₄²⁻, S₂O₅²⁻, S₂O₆²⁻, S₂O₇²⁻, S₂O₈²⁻, H₂PO₂⁻, H₂PO₄⁻, HPO₄²⁻, PO₄³⁻, P₂O₇⁴⁻, (OCₙH₂ₙ₊₁)⁻, (CₙH₂ₙ₋₁O₂)⁻, (CₙH₂ₙ₋₃O₂)⁻ and (Cₙ₊₁H₂ₙ₋₂O₄)²⁻, where n stands for the numbers 1 to 20.

Particularly preferred in this context are cesium carboxylates, in which the anion conforms to the formulae (CₙH₂ₙ₋₁O₂)⁻ and also (Cₙ₊₁H₂ₙ₋₂O₄)²⁻ with n equal to 1 to 20. Very particularly preferred cesium salts have anions comprising monocarboxylates of the formula (CₙH₂₋₁O₂)⁻, where n stands for the numbers 1 to 20. Particular mention should be made here of formate, acetate, propionate, hexanoate, and 2-ethylhexanoate.

The cesium salts are used in amounts of from 0.01 to 10 mmol of cesium salt per kg of solvent-free batch. They are preferably used in amounts from 0.05 to 2 mmol of cesium salt per kg of solvent-free batch.

The cesium salts may be added to the batch in solid form but are preferably added in dissolved form. Suitable solvents include polar aprotic solvents and also protic solvents. Particularly suitable solvents in addition to water include alcohols; very particular suitability is possessed by polyols, such as are also used otherwise as building blocks for polyurethanes, such as ethanediols, propanediols, and butanediols, for example. The use of the cesium salts allows the polyaddition to be conducted under the customary conditions.

Suitable polymerization apparatus for conducting the polyaddition comprises stirred tanks, especially when solvents are used to ensure a low viscosity and effective heat dissipation.

Preferred solvents are of unlimited miscibility with water, have a boiling point of from 40 to 100° C. under atmospheric pressure, and react slowly, if at all, with the monomers.

The dispersions are usually prepared by one of the following methods:

In the acetone process an ionic polyurethane is prepared from components (a) to (c) in a water-miscible solvent which boils at below 100° C. under atmospheric pressure. Water is added until a dispersion is formed in which water is the coherent phase.

The prepolymer mixing process differs from the acetone process in that rather than a fully reacted (potentially) ionic polyurethane it is a prepolymer carrying isocyanate groups which is prepared first of all. In this case, the components are chosen such that the above-defined ratio A:B is greater than 1.0 to 3, preferably 1.05 to 1.5. The prepolymer is first dispersed in water and then crosslinked, possibly by reacting the isocyanate groups with amines which carry more than 2 isocyanate-reactive amino groups, or is chain extended with amines which carry 2 isocyanate-reactive amino groups. Chain extension also takes place when no amine is added. In this case, isocyanate groups are hydrolyzed to amino groups, which react with residual isocyanate groups of the prepolymers and so extend the chain.

If a solvent has been used in preparing the polyurethane, it is usual to remove the majority of the solvent from the dispersion, for example by distillation under reduced pressure. The dispersions preferably have a solvent content of less than 10% by weight and are, with particular preference, free from solvents.

The dispersions generally have a solids content of from 10 to 75, preferably from 20 to 65, % by weight and a viscosity of from 10 to 500 mPas (measured at 20° C. and at a shear rate of 250 s⁻¹)

Hydrophobic auxiliaries, which in some cases are difficult to disperse homogeneously in the finished dispersion, examples being phenol condensation resins formed from aldehydes and phenol or phenol derivatives or epoxy resins and other polymers set out, for example, in DE-A-39 03 538, 43 09 079 and 40 24 567, and which are used, for example, as adhesion promoters in polyurethane dispersions, can be added to the polyurethane or to the prepolymer, prior to dispersion, in accordance with the methods described in the two abovementioned documents.

The polyurethane dispersions may include commercially customary auxiliaries and additives such as blowing agents, defoamers, emulsifiers, thickeners, thixotropic agents and colorants, such as dyes and pigments.

The dispersions of the invention are suitable for coating articles made of metal, plastic, paper, textile, leather or wood by applying said dispersions in the form of a film to these articles in accordance with generally customary techniques, such as by spraying or knife coating, for example, and drying the dispersion.

The dispersions are particularly suitable for coating articles made of plastic, paper, textile or leather if the dispersion is first beaten to a foam by known methods and said articles are coated with this foam.

The aqueous dispersions are suitable in particular for preparing formulations as described in DE-A 19 605 311. In accordance with the teaching of DE-A 19 605 311 these formulations are used for coating textiles or nonwovens. As a result of this treatment, these materials become flame retardant, waterproof to liquid. water, and permeable to water vapor.

To prepare the coated textiles or nonwovens, the aqueous dispersions of the invention are applied to the textile base materials by customary techniques such as knife coating or brushing and the coated base material is subsequently dried.

The preferred procedure is as follows:

The aqueous dispersion is applied in foam form to the base material, since this considerably improves the vapor permeability. For this purpose the dispersion, following the addition of the foam stabilizer and any thickener and other additives such as flame retardants, is mechanically foamed. This can be done in a foam mixer with the input of high shear forces. An alternative is to carry out foaming in a foam generator by blowing compressed air in. Foaming is preferably carried out using a foam generator.

The foamed coating composition is then applied to the base material with customary coating equipment, such as a coating blade or bar or other foam applicators. Application can be made to one or both sides, preferably to one side. The amount applied per side is from 20 to 150 g/m², in particular from 50 to 90 g/m².

With amounts below 20 g/m² the substrate, although having good vapor permeability for a low cost, is not very waterproof. With amounts above 150 g/m² there are instances of cracking in the course of drying.

Articles made of metal, plastic, paper, leather or wood may likewise be adhesively bonded to other articles, preferably the aforementioned articles, by applying the aqueous dispersion of the invention in the form of a film to one of said articles and joining it to another article before or after the film is dried.

Articles made of textile, leather or paper may be impregnated with the dispersions of the invention by soaking said articles with the aqueous dispersion and then drying them.

The aqueous dispersions of the invention are obtainable using nontoxic catalysts, so making the likewise inventive preparation process easier to implement. A further one of the features of the aqueous dispersions of the invention is that they comprise a polyurethane which exhibits no unwanted branching in the polymer chain, since the cesium salts used in accordance with the invention do not catalyze side reactions leading to the formation of unwanted allophanate, isocyanurate, or carbodiimide groups. The aqueous dispersions of the invention are especially suitable for coating textiles or leather.

### EXPERIMENTAL SECTION

### EXAMPLE

800.0 g (0.40 mol) of a polyesterdiol made from adipic acid, neopentyl glycol and 1,6-hexanediol with an OH number of 56, 34.0 g (0.0099 mol) of a polyethylene oxide started from butanol, with an OH number of 15 and 0.58 g of a solution of 1 g of cesium acetate in 9 g of 1,4-butanediol were charged to a stirring flask and brought to 70° C. 85.8 g (0.3248 mol) of HMDI and 70.8 g (0.3185 mol) of IPDI were added and the mixture was stirred at 100° C. for 135 minutes. It was then diluted with 1160 g of acetone and cooled to 50° C. and the NCO content was determined as being 0.99% by weight (calculated: 0.91% by weight). 10 minutes after the addition of 44.6 g of a 50% strength aqueous solution of the sodium salt of 2-aminoethyl-2-aminoethanesulfonic acid, the product was dispersed with 1200 g of water and then chain extended with 7.8 g of DETA and 3.6 g of IPDA in 100 g of water.

Distillation of the acetone gave a fine dispersion of solids content of approximately 40%.

### COMPARATIVE EXAMPLE

The inventive example was repeated but without addition of the cesium acetate solution. After 260 minutes of stirring at 100° C., an NCO content of 1.15% by weight was found. 10 minutes after the addition of 44.6 g of a 50% strength aqueous solution of the sodium salt of 2-aminoethyl-2-aminoethanesulfonic acid, the product was dispersed with 1200 g of water and then chain extended with 7.8 g of DETA and 3.6 g of IPDA in 100 g of water. Distillation of the acetone gave a fine dispersion having a solids content of approximately 40%.

Abbreviations:

HMDI di(isocyanatocyclohexyl)methane
IPDI isophorone diisocyanate
DETA diethylenetriamine
IPDA isophoronediamine

We claim:

1. An aqueous dispersion comprising a polyurethane composed of
a) diisocyanates,
b) diols of which
b₁) from 10 to 100 mol %, based on the total amount of diols (b), have a molecular weight of from 500 to 5000, and
b₂) from 0 to 90 mol %, based on the total amount of diols. (b), have a molecular weight of from 60 to 500 g/mol,
c) monomers other than the monomers (a) and (b), containing at least one isocyanate group or at least one isocyanate-reactive group and further carrying at least one hydrophilic group or potentially hydrophilic group by means of which the polyurethane is made dispersible in water,
d) if desired, further, polyfunctional compounds other than the monomers (a) to (c), containing reactive groups which are alcoholic hydroxyl groups, primary or secondary amino groups or isocyanate groups, and
e) if desired, monofunctional compounds which are other than the monomers (a) to (d) and contain a reactive group which is an alcoholic hydroxyl group, a primary or secondary amino group or an isocyanate group,
obtainable by reacting the monomers a), b), c), and, where used, d) and e) in the presence of a cesium salt.

2. An aqueous dispersion as claimed in claim 1, wherein diisocyanates (a) comprise 1-isocyanato-3,5,5-trimethyl-5-isocyanatomethylcyclohexane (IPDI), tetramethylxylylene diisocyanate (TMXDI), hexamethylene diisocyanate (HDI), and bis(4-isocyanatocyclohexyl)methane (HMDI).

3. An aqueous dispersion as claimed in claim 1 or 2, wherein the diols (b₁) comprise polyesterdiols, polyetherdiols or mixtures thereof.

4. An aqueous dispersion as claimed in any of claims 1 to 3, wherein diols (b₂) comprise diols having from 2 to 12 carbon atoms.

5. An aqueous dispersion as claimed in any of claims 1 to 4, wherein monomers (c) comprise 2-aminoethyl-2-aminoethane-sulfonic acid or 2-aminoethyl-2-aminoethanecarboxylic acid and the corresponding alkali metal salts thereof.

6. An aqueous dispersion as claimed in any of claims 1 to 5, wherein monomers a), b), c), and, where used, d) and e) are reacted at temperatures from 20 to 180° C. for average times from 1.5 to 20 hours.

7. An aqueous dispersion as claimed in any of claims 1 to 6, wherein monomers a), b), c), and, where used, d) and e) are reacted in the presence of a cesium carboxylate.

8. A process for preparing an aqueous dispersion comprising a polyurethane composed of
a) diisocyanates,
b) diols of which
b₁) from 10 to 100 mol %, based on the total amount of diols (b), have a molecular weight of from 500 to 5000, and
b₂) from 0 to 90 mol %, based on the total amount of diols (b), have a molecular weight of from 60 to 500 g/mol,
c) monomers other than the monomers (a) and (b), containing at least one isocyanate group or at least one isocyanate-reactive group and further carrying at least one hydrophilic group or potentially hydrophilic group by means of which the polyurethane is made dispersible in water,
d) if desired, further, polyfunctional compounds other than the monomers (a) to (c), containing reactive groups which are alcoholic hydroxyl groups, primary or secondary amino groups or isocyanate groups, and
e) if desired, monofunctional compounds which are other than the monomers (a) to (d) and contain a reactive group which is an alcoholic hydroxyl group, a primary or secondary amino group or an isocyanate group,
which comprises reacting the monomers a), b), c), and, where used, d) and e) in the presence of a cesium salt.

9. A method of coating an article of metal, plastic, paper, textile, leather or wood, which comprises applying to said article an aqueous dispersion as claimed in any of claims 1 to 7 in the form of a film and drying the dispersion.

10. A method of adhesively bonding an article of metal, plastic, paper, textile, leather or wood, which comprises applying to said article an aqueous dispersion as claimed in any of claims 1 to 7 in the form of a film and joining said article to another article before or after drying the film.

11. A method of impregnating an article of textile, leather or paper, which comprises soaking said article with an aqueous dispersion as claimed in any of claims 1 to 7 and then drying it.

12. An article coated, adhesively bonded or impregnated with an aqueous dispersion as claimed in any of claims 1 to 7.

13. The use of an aqueous dispersion as claimed in any of claims 1 to 7 as a hydrolysis-resistant coating for an article made of metal, plastic, paper, textile, leather or wood.
